(19) United States
(12) Patent Application Publication
(10) Pub. No.: US 2009/0146044 A1
(43) Pub. Date: Jun. 11, 2009

(54) OPTICAL DISPLACEMENT DETECTION APPARATUS AND OPTICAL DISPLACEMENT DETECTION METHOD

(75) Inventors: Hui-Hsuan Chen, HsinChu (TW); Hsin-Chia Chen, HsinChu (TW); Han-Chi Liu, HsinChu (TW); Yu-Chun Huang, HsinChu (TW); Ching-Lin Chung, HsinChu (TW)

Correspondence Address: Tung & Associates, 838 W. Long Lake Road, Suite 120, Bloomfield Hills, MI, 48302, US

(73) Assignee: PixArt Imaging Incorporation

(21) Appl. No.: 11/950,710

(22) Filed: Dec. 5, 2007

(51) Int. Cl. G01J 1/20; G01J 3/50

(52) U.S. Cl. 250/201.1; 250/216; 250/226

(57) ABSTRACT

The present invention discloses an optical displacement detection apparatus and an optical displacement detection method. The optical displacement detection apparatus comprises: at least two light sources for projecting light of different spectrums to a surface under detection, respectively; an image capturing unit for receiving light reflected from the surface under detection and converting it into electronic signals; and a processor and control circuit for calculating displacement according to the electronic signals from the image capturing unit, wherein the processor and control circuit is capable of switching between the light sources.

### FIELD OF THE INVENTION

The present invention relates to an optical displacement detection apparatus and an optical displacement detection method, which adaptively adjust the light spectrum according to reflected light from a detected object, so as to calculate the displacement more accurately.

### BACKGROUND OF THE INVENTION

Optical displacement detection apparatus has been widely used in many applications, one of which is the optical mouse. In an optical mouse, light emitted from a light source is projected on the surface of a desk or an object, reflected thereby, and received by a sensor chip inside the optical mouse. The sensor chip converts the optical signals into electronic signals, which are processed by a processor to determine the displacement of the mouse.

Currently there are two types of mice, one of which employs a general light emission diode (LED), most often red LED, to emit light, and the other of which employs a laser LED to emit light. In the context of this specification, a mouse which employs a general LED is referred to as a “general optical mouse”, while a mouse which employs a laser LED is referred to as a “laser mouse”, and collectively, “optical mice”.

The general optical mouse and the laser mouse operate under the same principle; their differences are in the light spectrums they use and the capability to recognize the surface under detection. A general optical mouse detects the pattern on the surface, and a laser mouse detects the roughness of the surface. Hence, each type of mouse has its strength and weakness.

More specifically, for a general optical mouse, when the surface under detection has a color similar to that emitted by the LED, the strong light scattering effect will reduce the sensitivity of the sensor chip to recognize the pattern on the surface. The features of the pattern become less recognizable, causing inaccurate displacement calculation.

For a laser mouse, when the roughness of the surface under detection is too low, even if there is a clear pattern on the surface, misjudgment may occur.

U.S. Pat. No. 6,963,059 proposes a method to regulate the power of a light source. However, this does not solve the above problem.

The present invention proposes a solution to the above problem in prior art.

### SUMMARY OF THE INVENTION

A first objective of the present invention to provide an optical displacement detection apparatus, which adaptively adjusts the light spectrum according to reflected light from a detected object, so as to calculate the displacement more accurately.

A second objective of the present invention is to provide an optical displacement detection method.

To achieve the foregoing objectives, and from one aspect of the present invention, an optical displacement detection apparatus comprises: at least two light sources for projecting light of different spectrums to a surface under detection, respectively; an image capturing unit for receiving light reflected from the surface under detection and converting it into electronic signals; and a processor and control circuit for calculating displacement according to the electronic signals from the image capturing unit.

In the above-mentioned apparatus, the light sources may be general LEDs of different colors, or a general LED and a laser LED.

In another aspect of the present invention, an optical displacement detection apparatus comprises: a light sources for projecting mixed light to a surface under detection, the mixed light includes at least two primary wavelengths; an image capturing unit for receiving light reflected from the surface under detection and converting light of different wavelengths into different electronic signals; and a processor and control circuit for calculating displacement according to the electronic signals from the image capturing unit.

In the above-mentioned apparatus, preferably, the image capturing unit includes two sensor circuits having color filter layers of different colors, respectively, or the apparatus further includes two color lenses to filter light to be sensed by the two sensor circuits, respectively.

From yet another aspect of the present invention, an optical displacement detection method, comprising: providing at least two light sources for projecting light of different spectrums, respectively; projecting light from one of the light sources; receiving an image formed by the light; determining the quality of the image; when the quality is good, calculating displacement according to the image; and when the quality is not good, switching to another light source.

In the above-mentioned method, when an image does not present a meaningful feature, its quality is not good (poor).

From a further aspect of the present invention, an optical displacement detection method, comprising: projecting mixed light including at least two primary wavelengths; sensing light of the at least two primary wavelengths, to capture at least two images respectively corresponding to the light of the at least two primary wavelengths; determining the quality of at least one of the images; when the quality is good, calculating displacement according to this image whose quality is determined to be good; and when the quality is not good, calculating displacement according to another image.

In the above-mentioned method, the step of determining the quality of at least one of the images determines the quality of at least two of the images, and the displacement is calculated according to the image with a better quality. Or, the step of determining the quality of at least one of the images determines the quality of only one image at a given time point, and when the quality is not good, the method further comprises the step of switching to another image.

For better understanding the objects, characteristics, and effects of the present invention, the present invention will be described below in detail by illustrative embodiments with reference to the attached drawings.

### BRIEF DESCRIPTION OF THE DRAWINGS

FIG. 1 shows a first embodiment of the present invention.

FIGS. 2 and 3 show the spectrums of different LEDs.

FIG. 4 shows a flow chart corresponding to the embodiment of FIG. 1.

FIGS. 5A and 5B show two embodiments of the processor and control circuit 18.

FIG. 6 shows another embodiment of the present invention.

FIG. 7 shows a flow chart corresponding to the embodiment of FIG. 6.

### DESCRIPTION OF THE PREFERRED EMBODIMENT

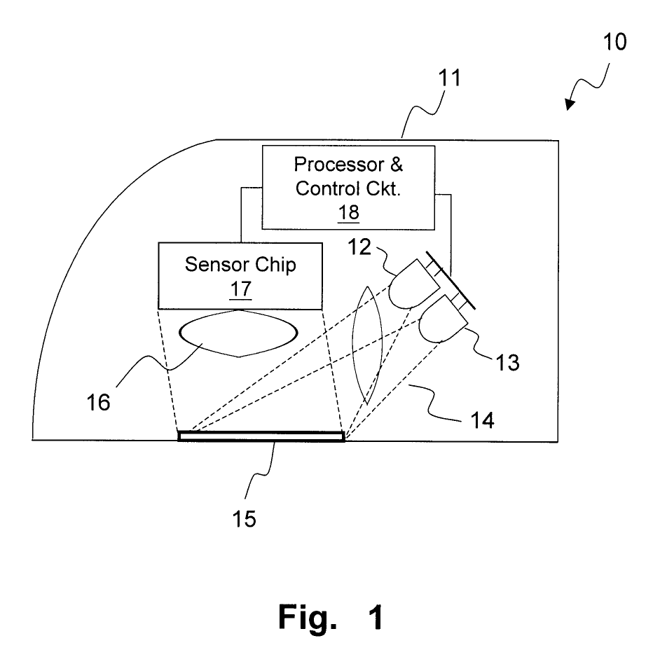

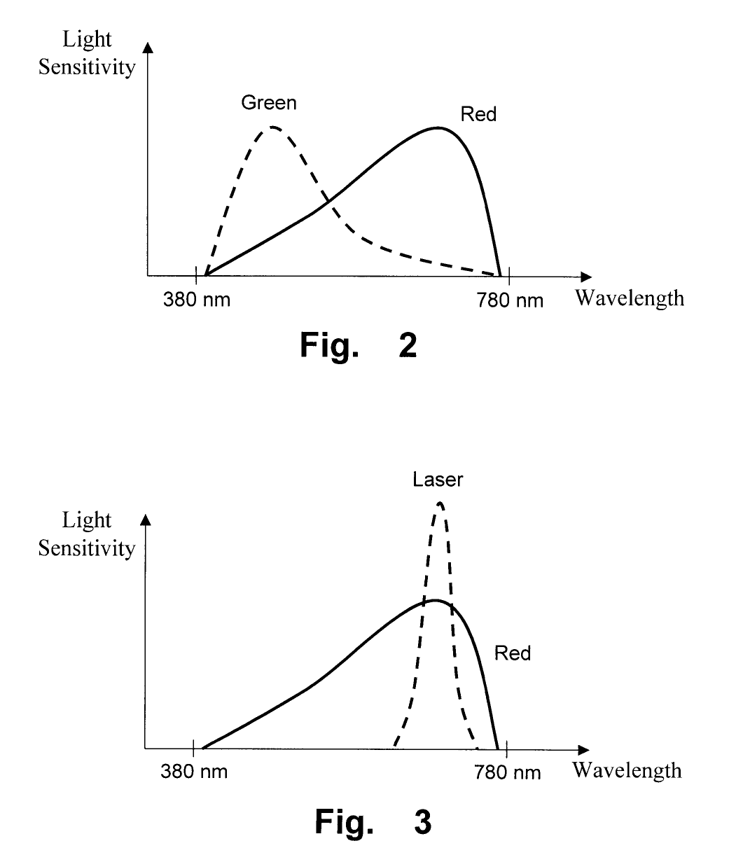

FIG. 1 shows a first embodiment of the present invention. The mouse 10 of this embodiment includes, in its housing 11, two light sources 12 and 13 so that the mouse 10 can switch its light source. The two light sources may be two general LEDs of different colors, such as red and green, or a general LED and a laser LED. The spectrums of red and green LEDs are shown in FIG. 2, and the spectrums of a general LED and a laser LED are shown in FIG. 3. As shown in the figures, different LEDs have different bandwidths and light sensitivities.

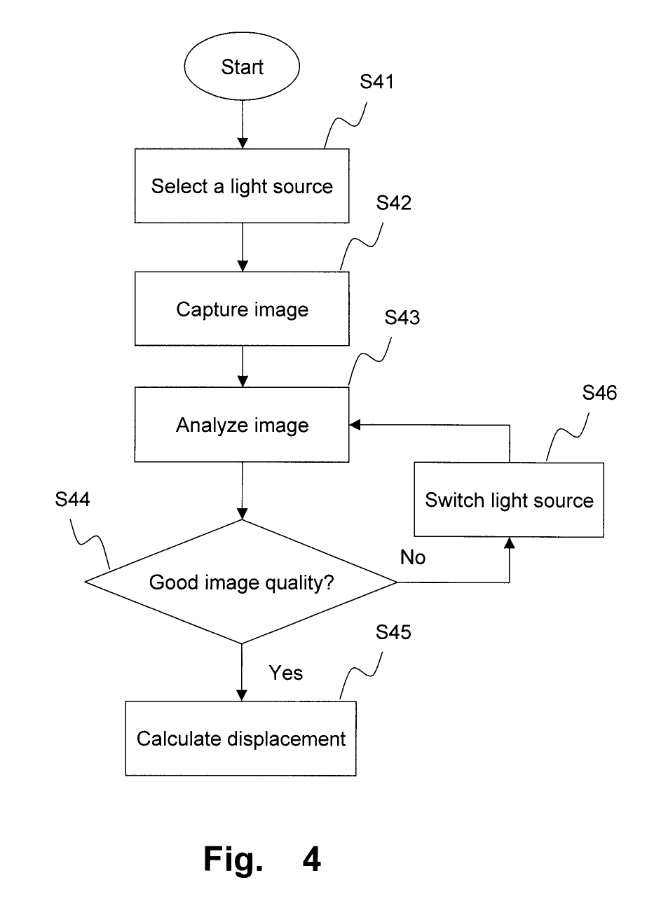

Referring to FIG. 1 in conjunction with the flow chart of FIG. 4, when the mouse 10 starts to operate, it can arbitrarily select one of its light sources, such as the light source 12 (step S41). The light emitted from the light source 12, after condensed by a first lens 14, passes through an opening 15 on the mouse housing and projects on the surface of a desk or an object (not shown). The light reflected from the surface passes though a second lens 16 and is received by an image capturing device (step S42). In one embodiment, the image capturing device is a sensor chip 17; however, it can be any other device capable of capturing an image. The sensor chip 17 converts the received optical signals into electronic signals, and outputs the electronic signals to a processor and control circuit 18 for analysis (step S43).

When the image received by the sensor chip 17 presents recognizable features, the processor and control circuit 18 calculates displacement according to any proper method well known by those skilled in this art (step S45). For example, if the light source 12 is a general LED, the displacement can be calculated by comparing the patterns of two successive images. If the light source 12 is a laser LED, the displacement can be calculated by comparing the locations of a roughness feature in two successive images. The details of such calculation are omitted here because they are not the critical part of the present invention.

When the surface under detection has a color similar to the color of the light source 12 so that the image received by the sensor chip 17 does not present a good quality feature, the processor and control circuit 18 sends a control signal to switch to the other light source 13 (step S46). The light spectrum changes and thus it avoids the trouble caused by scattering. Or, if the light source 12 is a laser LED, when the surface under detection has low roughness so that the image received by the sensor chip 17 does not present a good quality feature, the processor and control circuit 18 sends a control signal to switch to the other light source 13 (step S46). When the image received by the sensor chip 17 presents recognizable features, the processor and control circuit 18 calculates displacement of the mouse based on the features (step S45).

By way of example, the “feature” mentioned above can be extracted, or recognized, according to a method below: generating a brightness distribution map for the received image, and defining pixels which have an absolute or relative brightness value larger than a threshold to be features. The displacement can be calculated by comparing the features of two successive images. On the other hand, if there is no meaningful feature in an image, for example when the feature ratio (the feature area over total area) of an image is too high or too low, it means that the image has poor quality.

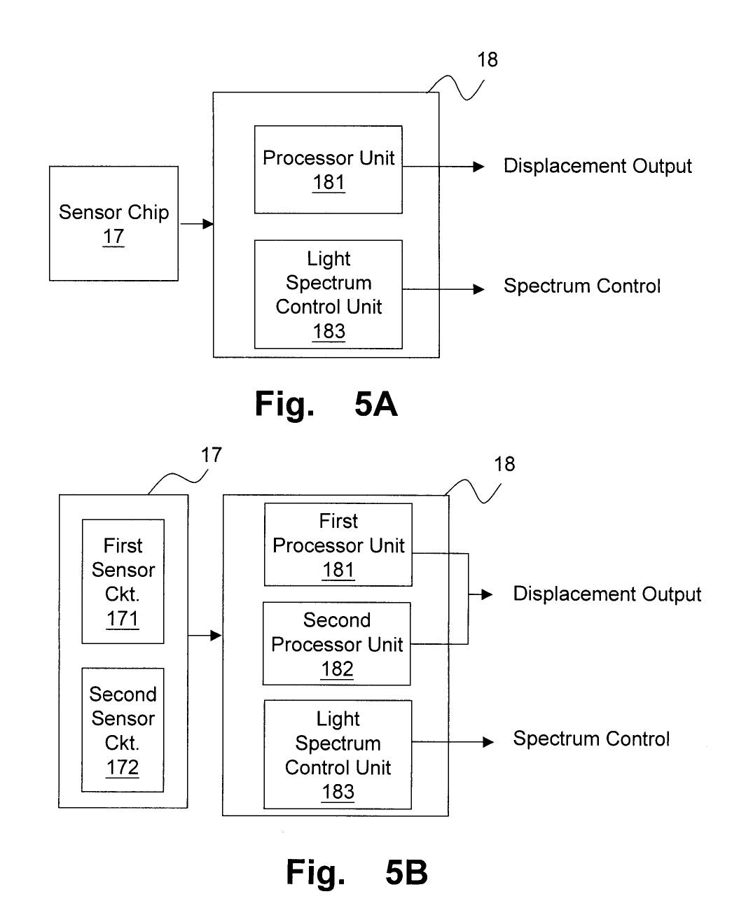

FIGS. 5A and 5B show internal circuit structure of the processor and control circuit 18. If both the light sources 12 and 13 are general LEDs, only one sensor circuit and a corresponding processor unit 181 are required. If the light sources 12 and 13 are a general LED and a laser LED, it requires two sensor circuits 171 and 172 to sense normal light and laser light, and two processor units 181 and 182 to calculate displacement according to different types of features. Note that the hardware structures in the figures are only examples among many possible arrangements. The two sensor circuits 171 and 172 can be integrated into one circuit, and the calculation of displacement according to different types of features can be done by the same processor unit according to different algorithms, e.g., different programs or different subroutines in the same program.

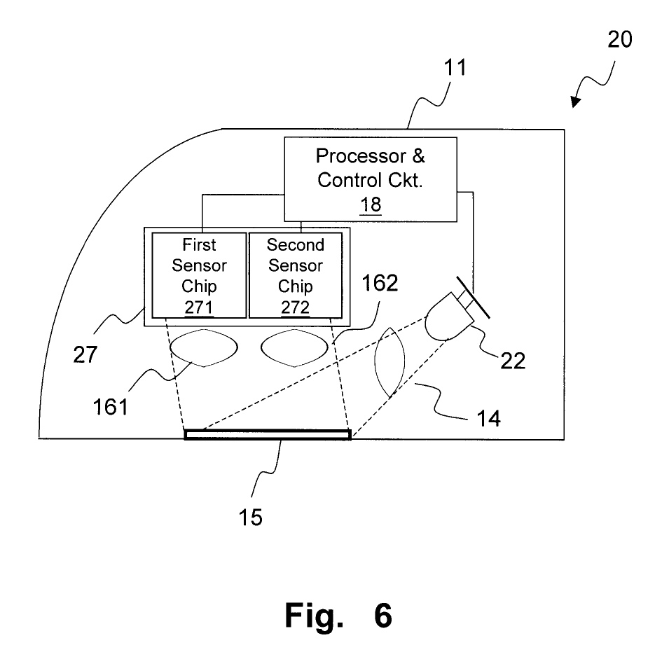

FIG. 6 shows another embodiment of the present invention. The mouse 20 in this embodiment includes only one light source 22. The light source 22 emits mixed light which includes at least two primary wavelengths. For example, the light source 22 can be a white LED, or any other light source capable of emitting mixed light.

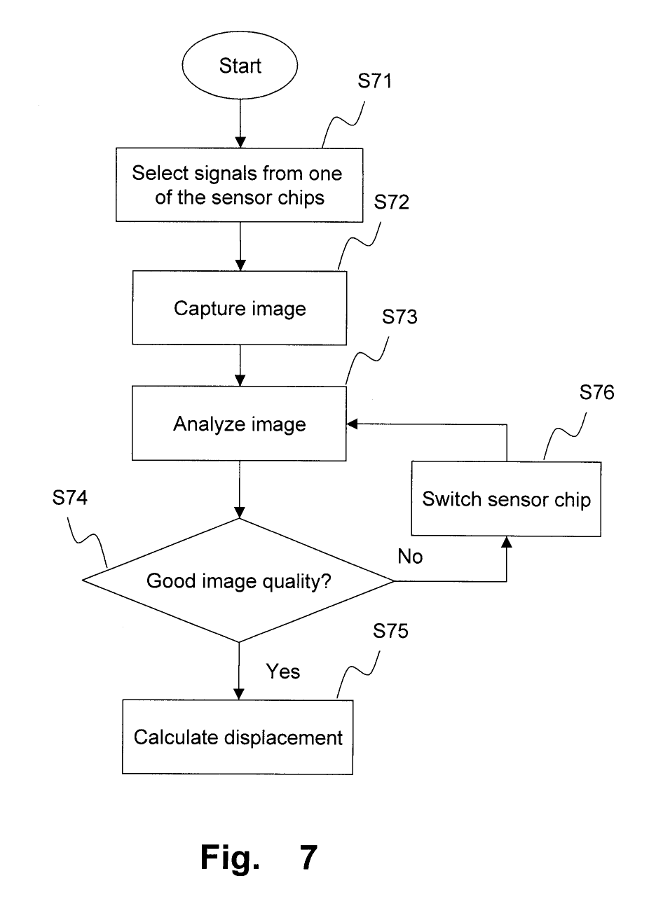

The light emitted from the light source 22, after condensed by a first lens 14, passes through an opening 15 on the mouse housing and projects on the surface of an object (not shown). It is reflected by the surface and returns to the inside of the mouse. This embodiment is different from the previous embodiment in that the image capturing unit 27 includes two sensor circuits 271 and 272 to sense different wavelengths of light. In one embodiment, different wavelengths of light may be sensed by providing two filter lenses 161 and 162 of different colors, as shown in the figure. In another embodiment (not shown), only one lens is provided, but the two sensor circuits 271 and 272 are each provided with a color filter layer of a different color. The two sensor circuits 271 and 272 sense different wavelengths of light and convert the optical signals into electronic signals. The electronic signals are transmitted to the processor and control circuit 18. The processor and control circuit 18 calculates displacement according to the signals from one of the sensor circuits. More specifically, in one embodiment, the processor and control circuit 18 receives the signals from both sensor circuits 271 and 272, and calculates displacement according to the signals with better image quality. In another embodiment, the processor and control circuit 18 switches between signals from two sensor circuits 271 and 272, that is, it only receives signals from one of the sensor circuits at a given time point, and it judges the image quality according to the received signals. If the image quality is poor, the processor and control circuit 18 switches to signals from the other sensor circuit, as shown by steps S71-S76 of FIG. 7.

By switching between signals resulting from different wavelengths of light, this embodiment also avoids the problem caused by light scattering due to similar colors of the surface under detection and the light source.

The optical displacement detection apparatus and method disclosed by the present invention not only can be applied to optical mice, but also can be applied to any other apparatus which is designed to trace the movement of an object.

The features, characteristics and effects of the present invention have been described with reference to its preferred embodiments, for illustrating the spirit of the invention rather than limiting the scope of the invention. Various other substitutions and modifications will occur to those skilled in the art, without departing from the spirit of the present invention. For example, the lenses shown in the embodiments are not necessarily required. Each of the circuits 17, 18, 171, 172, 181, 182, 183, 271 and 272 does not have to be a stand-alone circuit as shown, but instead can be integrated with other circuits in various manners. Thus, all such substitutions and modifications are intended to be embraced within the scope of the invention as defined in the appended claims.

What is claimed is:

1. An optical displacement detection apparatus, comprising:
at least two light sources for projecting light of different spectrums to a surface under detection, respectively;
an image capturing unit for receiving light reflected from the surface under detection and converting it into electronic signals; and
a processor and control circuit for calculating displacement according to the electronic signals from the image capturing unit.

2. The optical displacement detection apparatus according to claim 1, wherein the at least two light sources includes general LEDs of different colors.

3. The optical displacement detection apparatus according to claim 1, wherein the at least two light sources includes at least a general LED and a laser LED.

4. The optical displacement detection apparatus according to claim 3, wherein the image capturing unit includes two sensor circuits for sensing general light and laser light and generating corresponding electronic signals, respectively.

5. The optical displacement detection apparatus according to claim 4, wherein the processor and control circuit includes two processor units for calculating displacement according to the electronic signals corresponding to the general light and the laser light, respectively.

6. The optical displacement detection apparatus according to claim 4, wherein the processor and control circuit calculates displacement according to the electronic signals corresponding to the general light and the laser light by different algorithms, respectively.

7. The optical displacement detection apparatus according to claim 1, wherein the processor and control circuit is capable of switching between the light sources.

8. The optical displacement detection apparatus according to claim 7, wherein the light received by the image capturing unit forms an image, and the processor and control circuit switches between the light sources according to the quality of the image.

9. The optical displacement detection apparatus according to claim 8, wherein the quality of the image is determined by the feature ratio of the image.

10. An optical displacement detection apparatus, comprising:
a light sources for projecting mixed light to a surface under detection, the mixed light includes at least two primary wavelengths;
an image capturing unit for receiving light reflected from the surface under detection and converting light of different wavelengths into different electronic signals; and
a processor and control circuit for calculating displacement according to the electronic signals from the image capturing unit.

11. The optical displacement detection apparatus according to claim 10, wherein the image capturing unit includes at least two sensor circuits for sensing general light of different colors, respectively.

12. The optical displacement detection apparatus according to claim 11, wherein the at least two sensor circuits includes color filter layers of different colors, respectively.

13. The optical displacement detection apparatus according to claim 11, further comprising at least two color lenses to filter light to be sensed by the at least two sensor circuits, respectively.

14. The optical displacement detection apparatus according to claim 11, wherein the processor and control circuit receives the signals from both or all of the at least two sensor circuits and calculates displacement according to one of the signals.

15. The optical displacement detection apparatus according to claim 11, wherein the processor and control circuit switches between the signals from the at least two sensor circuits and calculates displacement according to the signal it receives.

16. The optical displacement detection apparatus according to claim 15, wherein the light received by the image capturing unit forms an image, and the processor and control circuit switches between the signals according to the quality of the image.

17. The optical displacement detection apparatus according to claim 16, wherein the quality of the image is determined by the feature ratio of the image.

18. An optical displacement detection method, comprising:
providing at least two light sources for projecting light of different spectrums, respectively;
projecting light from one of the light sources;
receiving an image formed by the light;
determining the quality of the image;
when the quality is good, calculating displacement according to the image; and
when the quality is not good, switching to another light source.

19. The optical displacement detection method according to claim 18, wherein the at least two light sources includes general LEDs of different colors.

20. The optical displacement detection method according to claim 18, wherein the at least two light sources includes at least a general LED and a laser LED.

21. The optical displacement detection method according to claim 18, wherein the quality of the image is determined by the feature ratio of the image.

22. An optical displacement detection method, comprising:
projecting mixed light including at least two primary wavelengths;
sensing light of the at least two primary wavelengths, to capture at least two images respectively corresponding to the light of the at least two primary wavelengths;
determining the quality of at least one of the images;
when the quality is good, calculating displacement according to this image whose quality is determined to be good; and
when the quality is not good, calculating displacement according to another image.

23. The optical displacement detection method according to claim 22, wherein the step of determining the quality of at least one of the images determines the quality of at least two of the images, and the displacement is calculated according to the image with a better quality.

24. The optical displacement detection method according to claim 22, wherein the step of determining the quality of at least one of the images determines the quality of only one image at a given time point, and when the quality is not good, the method further comprises the step of switching to another image.

25. The optical displacement detection method according to claim 22, wherein the quality of the image is determined by the feature ratio of the image.
